(19) United States
(12) Patent Application Publication
(10) Pub. No.: US 2023/0202623 A1
(43) Pub. Date: Jun. 29, 2023

(54) SYSTEMS AND METHODS FOR WATER CLEANING

(71) Applicant: The Aros Project, Dallas, TX (US)

(72) Inventor: Emily Payne Hyde, Dallas, TX (US)

(21) Appl. No.: 17/989,667

(22) Filed: Nov. 17, 2022

Related U.S. Application Data
(60) Provisional application No. 63/294,635, filed on Dec. 29, 2021.

(51) Int. Cl. B63B 35/32; C02F 1/00; B63G 8/08; B63G 8/00; G05D 1/10; B60L 53/12; B63G 8/39; B63G 8/38; B60L 53/30; B63B 25/00

(52) U.S. Cl. CPC B63B 35/32; C02F 1/004; B63G 8/08; B63G 8/001; G05D 1/10; B60L 53/12; B63G 8/39; B63G 8/38; B60L 53/30; B63B 25/002; C02F 2103/007

(57) ABSTRACT

This disclosure relates generally to waste collection, storage, and retrieval from water. Aspects of this disclosure relate to submersible cleaning vehicles, filter systems, ships, communication systems, autonomous navigation, and computer systems. The submersible cleaning vehicle can navigate underwater to capture waste in filters. Abase station can support the submersible cleaning vehicle.

### CROSS-REFERENCE TO RELATED APPLICATION

This application claims the benefit of U.S. Provisional Patent Application No. 63/294,635, filed Dec. 29, 2021, the entirety of which is incorporated by reference herein.

### FIELD

This disclosure relates generally to waste collection, storage, and retrieval from water. Aspects of this disclosure relate to submersible cleaning vehicles, filter systems, ships, communication systems, autonomous navigation, and computer systems.

### BACKGROUND

Among other waste products, an estimated 8-12 million metric tons of plastic waste are dumped into the world's oceans each year. By 2025, sources estimate that this volume will increase tenfold.

### SUMMARY

There remains a need to provide an improved solution for collecting and disposing various forms of waste from water. Aspects of this disclosure provide a solution for collecting and disposing of waste from water with several technological benefits. A biomimetic appearance can advantageously reduce any ecological disruption caused by submersible cleaning vehicles roaming around the water. An arrangement of filters can advantageously collect waste particles of different sizes while allowing marine creatures to escape. The power system can advantageously use eco-friendly power sources and allow for convenient power delivery, such as during wet docking. A navigation and control system advantageously allows for more efficient waste collection. A disposal system advantageously simplifies waste removal and reduces maintenance.

Some aspects include a submersible vehicle. The submersible vehicle includes a hull, a propulsion system coupled to the hull, an opening in the hull to intake water, and a first filter positioned to receive the intake water. The first filter can have a first cross-sectional area at least 10% of a second cross-sectional area of the hull viewed in the direction of the intake. An exterior of the submersible vehicle has a biomimetic appearance.

The submersible vehicle can include one, some, all, or any combination of the following. The submersible vehicle further includes a second filter positioned to receive and filter the intake water that passes through the first filter, and the first filter catches a first set of particles larger than a second set of particles caught by the second filter. The submersible vehicle further includes a storage container configured to store waste collected by the first filter, the storage container comprising: a sealing opening; and an inflatable flotation device coupled to the storage container. The submersible vehicle further includes a beacon coupled to the storage container. The inflatable flotation device is configured to inflate in response to a triggering condition comprising at least one of: collecting a threshold amount of waste in the first filter, completing a cleaning route, reaching a location, cleaning an area, cleaning for a set amount of time, reaching a proximity to a collection location, and receiving an instruction to send waste for collection. The biomimetic exterior comprises a fin and a tail. The biomimetic exterior comprises gill-shaped openings. The propulsion system comprises a motor coupled to drive an impeller. The impeller draws water through the first filter when the impeller turns. A battery is coupled to deliver power to the propulsion system. A wet docking attachment is configured to dock the submersible vehicle to a base station while at least partially submerged. A wireless charging port receiver is configured to receive energy while the submersible vehicle remains wet docked, wherein the wireless charging port is electrically coupled to the battery. A plurality of sensors configured to collect data, including at least: a GPS receiver, and a sonar sensor. A processor is configured to receive data from the plurality of sensors, identify a topological feature, and navigate the submersible vehicle in an area while avoiding the topological feature. The submersible vehicle further comprises a plurality of sensors configured to collect data, including at least: a GPS receiver, a depth sensor, a lidar sensor, and a sonar sensor, and a processor configured to use an object recognition model to recognize objects based at least in part on sensor data from the plurality of sensors. The submersible vehicle further includes a damage sensor, a battery, and a processor configured to send a signal to deliver electricity from the battery to the hull based at least in part on response to the damage sensor detecting damage.

Some aspects feature a method comprising deploying a submersible vehicle into water to collect waste, collecting the waste using at least one filter of the submersible vehicle, and removing the waste from the filters in the submersible vehicle. The submersible vehicle comprises: a hull contributing to a biomimetic appearance of the submersible vehicle, a propulsion system coupled to the hull, an opening in the hull to intake water, and a first filter positioned to receive the intake water.

The method can include one, some, all, or any combination of the following. The method further includes charging a battery of the submersible vehicle while the submersible vehicle remains at least partially submerged. The method further includes receiving a first communication from the submersible vehicle, and in response to receiving the first communication, transmitting a second communication to a second submersible vehicle, and wherein the second submersible vehicle makes a navigational change in response to receiving the second communication. The method further includes receiving data from a plurality of submersible vehicles, based at least in part on the data from a plurality of submersible vehicles, detecting an object traveling toward a second submersible vehicle, and in response to detecting the object traveling toward a second submersible vehicle, sending a communication to the second submersible vehicle. The method further includes receiving data from a plurality of submersible vehicles; based at least in part on the data from a plurality of submersible vehicles, determining that a first area is dirtier than a second area, wherein a second submersible is deployed to clean the second area; and in response to the determining, sending a communication to cause the second submersible vehicle to clean the first area.

Some aspects feature an aquatic base station deployed in water for supporting submersible vehicles, the base station comprising: an attachment for docking a submersible vehicle; a communication transceiver configured to communicate with a submersible vehicle; a waste container for storing waste delivered by the submersible vehicle; and a charging port for recharging an energy reservoir of the submersible vehicle.

The aquatic base station can include one, some, all, or any combination of the following. The attachment for docking the submersible vehicle allows for wet docking beside or below the base station. The charging port is a wireless charging port configured to recharge an energy reservoir of the submersible vehicle while the submersible vehicle is wet docked.

Some aspects feature a submersible cleaning vehicle comprising: a filter, a navigation sensor, a propulsion system, a processor, a computer-readable storage medium storing instructions. When executed by the processor, the instructions cause the processor to control the submersible cleaning vehicle to perform actions comprising: navigating to a first area, navigating within the first area to collect waste in the filter, and returning to a base station.

The submersible cleaning vehicle can include one, some, all, or any combination of the following. The submersible cleaning vehicle further includes at least one of a lidar or sonar sensor, and wherein the instructions are further configured to cause the processor to control the submersible cleaning vehicle to: receive first data from the at least one of the lidar or sonar sensor; identify, based at least in part on the first data, an obstacle within the first area; and adjust a path to navigate within the first area while avoiding a collision with the obstacle. The submersible cleaning vehicle further includes at least one of a lidar or sonar sensor, wherein the computer-readable storage medium further stores a marine creature identification model, and wherein the instructions are further configured to cause the processor to control the submersible cleaning vehicle to: receive first data from the at least one of the lidar or sonar sensor; identify, based at least in part on the first data and using the marine creature identification model, a marine creature; and in response to the identification of the marine creature, navigate away from the marine creature. The submersible cleaning vehicle further includes a storage sensor, and wherein the instructions are further configured to cause the processor to control the submersible cleaning vehicle to: receive first data from the storage sensor indicating that at least a threshold amount of waste is collected, navigate to a base station to empty the waste, navigate back to the first area, and resume navigating within the first area to collect more waste in the filter. The submersible cleaning vehicle further includes a storage sensor and a storage container, and wherein the instructions are further configured to cause the processor to control the submersible cleaning vehicle to: receive first data from the storage sensor indicating that at least a threshold amount of waste is collected, seal the waste in a storage container, and release the storage container.

Details of one or more implementations of the subject matter described in this specification are set forth in the accompanying drawings and the description below. Other features, aspects, and advantages will become apparent from the description, the drawings, and the claims. This summary does not limit the scope of disclosure.

For purposes of summarizing the disclosure, certain aspects, advantages, and novel features have been described herein. It is to be understood that not necessarily all such aspects, advantages, or features are achieved in accordance with any particular example. Thus, the various examples may include or optimizes one or more aspects, advantages, or features as taught herein without necessarily achieving other aspects, advantages, or features as taught or suggested herein.

### BRIEF DESCRIPTION OF THE DRAWINGS

FIG. 1 shows an example system for deploying a submersible underwater-cleaning vehicle.

FIG. 2 shows an example submersible cleaning vehicle.

FIGS. 3-4 show examples of biomimetic exteriors.

FIG. 5 shows an example of a filtration system for collecting waste.

FIG. 6 shows an example placement of the filters from FIG. 5 within the biomimetic submersible cleaning vehicle of FIG. 4.

FIG. 7 shows an example storage system 207.

FIG. 8 shows an example system with a surfacing container.

FIG. 9 shows an example disposal system.

FIG. 10 shows an example propulsion system.

FIG. 11 shows two examples of propulsion systems coupled to biomimetic exteriors.

FIG. 12 shows an example power system in the biomimetic exterior.

FIG. 13 shows an example buoyancy system.

FIG. 14 shows an example electrical component system.

FIG. 15A shows a flowchart for navigating a submersible cleaning vehicle.

FIG. 15B shows three example sweeping paths for a submersible cleaning vehicle in an area.

FIG. 16 shows an example recognition system.

FIG. 17A shows an example security system.

FIG. 17B shows an example flowchart of a security process.

FIG. 18 shows an example of a system for directing submersible cleaning vehicles.

### DETAILED DESCRIPTION

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings. The headings are provided for convenience only and do not necessarily affect the scope or meaning of the claims.

### Introduction: Overview

This disclosure relates generally to waste collection, storage, and retrieval from water. Aspects of this disclosure relate to submersible cleaning vehicles, filter systems, ships, communication systems, and computer systems.

Surface plastic makes up only a part of the pollution problem, with most plastic waste now entering the oceans and traveling around the world below the surface. Aspects of this disclosure relate to systems, methods, and devices for underwater waste collection, as well as storage, transport, and disposal. This disclosure may refer to examples of collecting plastic and/or polymers, but the technology can apply to collecting any type of waste particle.

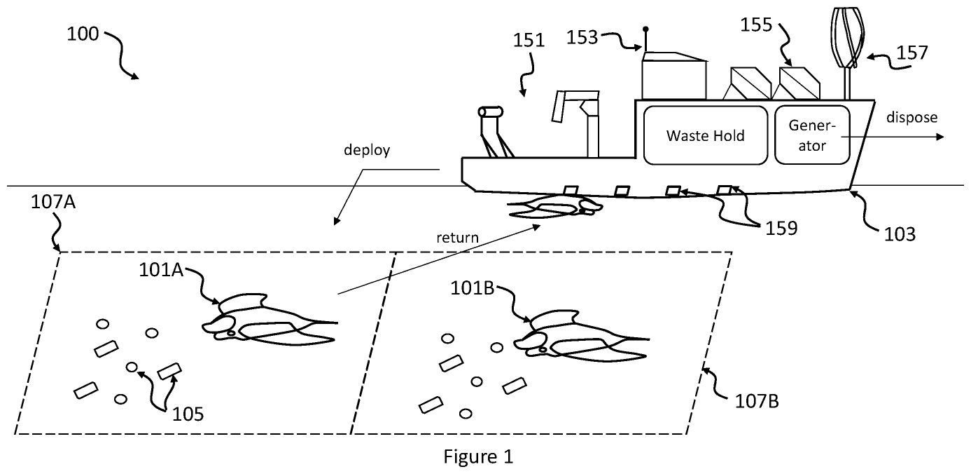

FIG. 1 shows an example system 100 for deploying one or more submersible underwater cleaning vehicles 101A, 101B (generally, 101). The system includes a plurality of submersible cleaning vehicles 101A, 101B and a base station 103 in the form of a boat. The submersible cleaning vehicle 101A deploys to collect waste 105, such as plastics, polymers, and/or other particles underwater. A plurality of submersible cleaning vehicles 101A, 101B may clean different locations 107A, 107B, for example, different geofenced locations.

### Example Submersible Cleaning Vehicle

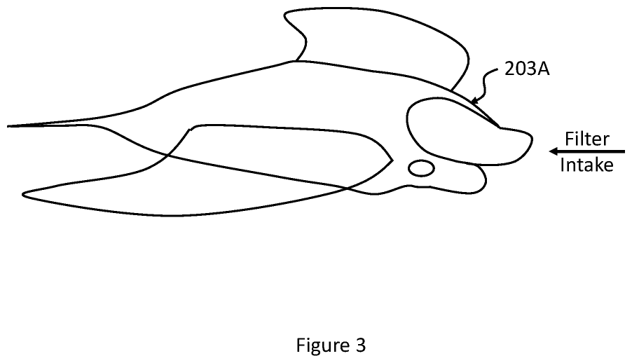

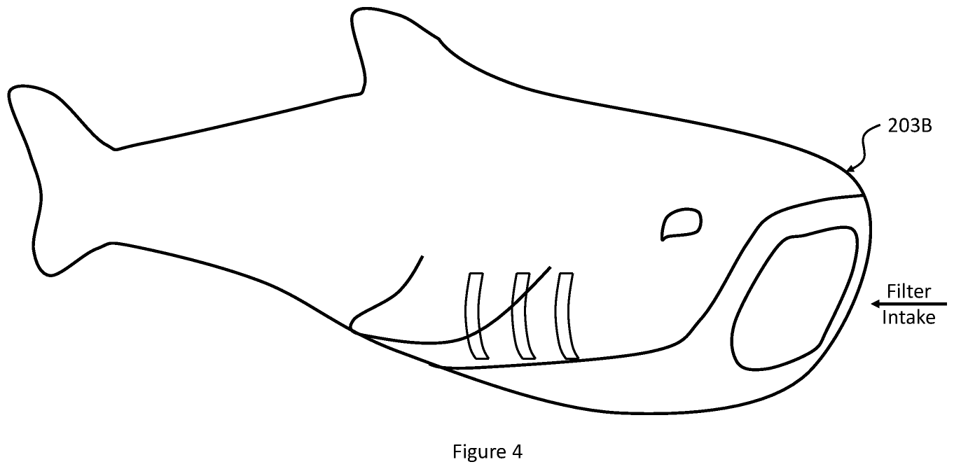

The submersible cleaning vehicles 101A, 101B may swim in a body of water to collect and store plastics, polymers, or other waste. FIG. 3 and FIG. 4, discussed in detail in a later section, show additional details of example submersible cleaning vehicles 101. In some cases, the submersible cleaning vehicle 101 can be configured to search for and collect waste on an autonomous, unmanned basis while uncoupled from any base station 103. In other cases, the submersible cleaning vehicle 101 may be piloted remotely or locally. The submersible cleaning vehicle 101 may operate to collect plastic and/or polymers 105 entirely underwater, on the surface, or both underwater and on the surface. Because surface plastic makes up only a part of the pollution problem and most plastic waste remains below the surface, the submersible cleaning vehicle 101 may spend most or all its time operating below the surface.

In some cases, the submersible cleaning vehicle 101 may have a biomimetic appearance. For example, the submersible cleaning vehicle 101 may have an exterior shape, structure, size, color, mechanical movement, and/or other feature similar to fish, sharks, manta rays, whales, or other biological creatures typically found in water. Example biomimetic features include eyes, mouth, body shape, fins, tail, gills, head, face, and/or their relative arrangement. FIG. 3, discussed in detail in a later section, shows an example of a submersible cleaning vehicle 101 with an exterior structure that mimics a manta ray. FIG. 4, discussed in detail in a later section, shows an example of a submersible cleaning vehicle 101 with an exterior structure that mimics a whale. A biomimetic appearance can advantageously reduce any ecological disruption caused by submersible cleaning vehicles 101 roaming around the water.

A submersible cleaning vehicle 101 may scale to large sizes to clean a volume of water more effectively. For example, the submersible cleaning vehicle 101 may be the size of a car, truck, city garbage-collection truck, or boat or larger. The submersible cleaning vehicle 101 may have sizes of 5 feet, 10 feet, 20 feet, 50 feet, 100 feet, or larger in one or more dimensions. Large submersible cleaning vehicles 101 may have lengths comparable to submarines or large boats—at tens, hundreds, or thousands of feet or longer.

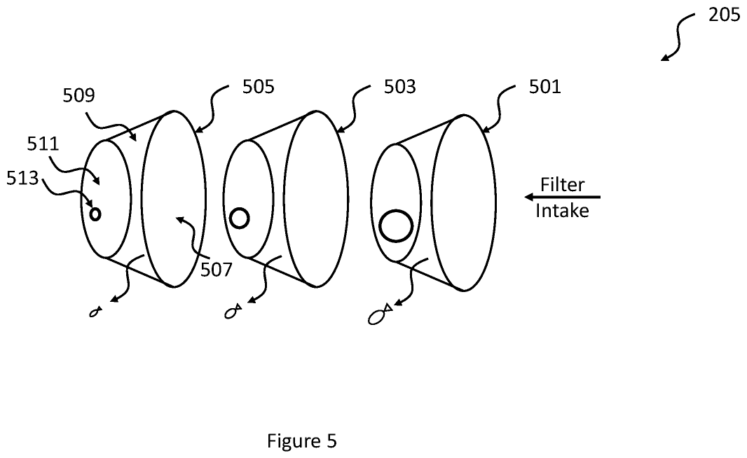

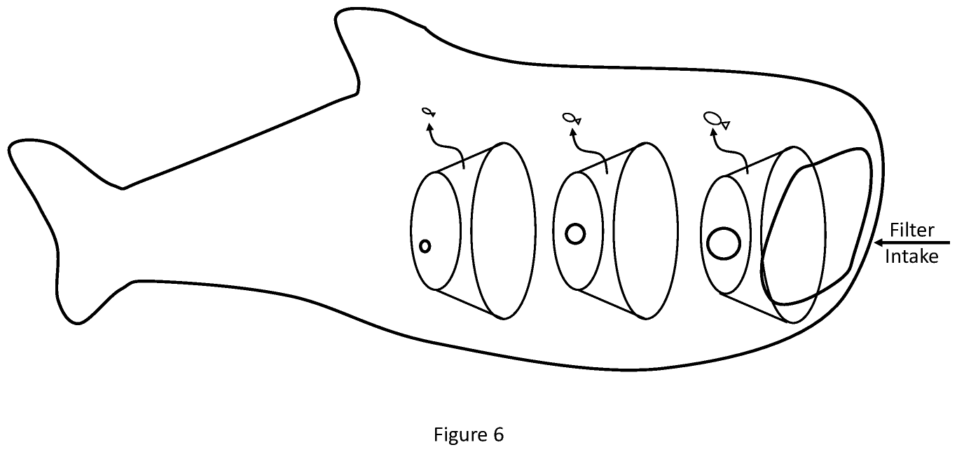

The submersible cleaning vehicles 101A, 101B may roam, patrol, sweep, or otherwise navigate a volume of water to collect plastic and/or polymer waste. The submersible cleaning vehicle 101 may have one or more filters to capture the plastic and/or polymer waste. FIG. 5 and FIG. 6, discussed in detail in a later section, show an example filter structure for the submersible cleaning vehicle. The submersible cleaning vehicle 101 collects and stores waste. In some cases, the submersible cleaning vehicle 101 may return to a base station 103 to dispose of the collected waste. In other cases, the submersible cleaning vehicle 101 may dispose of the waste using other techniques, such as by sealing the waste in a container and sending the waste to the surface for retrieval.

### Example Base Station

FIG. 1 shows a base station 103 in the form of a boat. In other cases, the base station may take the form of a dock, harbor, oil platform, or other structure capable of supporting similar capabilities. The base station 103 includes a generator, a waste holding area, a maintenance area 151, communication equipment 153, solar panels 155, a wind turbine 157, and charging ports 159.

The base station 103 may provide various forms of support for the submersible cleaning vehicle 101. The base station may provide for dry or wet docking of the submersible cleaning vehicle 101. The base station 103 may have facilities and tools for providing maintenance and repairs for the submersible cleaning vehicle 101. A boom system, claw, lift, pulley, rails, levers, ramp, wheeled carts, or other mechanical advantage system on the base station 103 may carry the submersible cleaning vehicle 101 across the base station, lower the submersible cleaning vehicle 101 into the water, and/or retrieve the submersible cleaning vehicle 101 from the water.

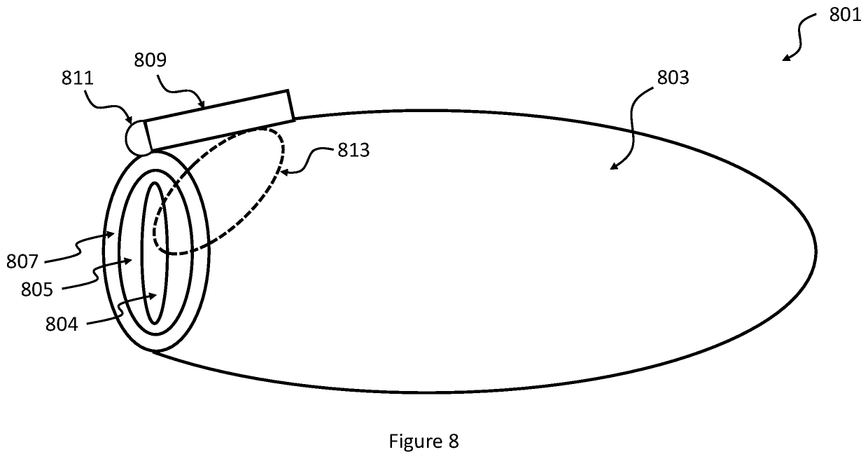

The base station 103 may collect and store the waste collected by the submersible cleaning vehicle. The base station may have a storage container for holding the waste. If the base station 103 takes the form of a boat or other mobile station, then in some cases, the base station can travel to retrieve the cleaning vehicle. In some cases, the base station 103 may also travel to retrieve waste collected and sent to the surface by the submersible cleaning vehicle 101, such as discussed in detail in a later section with respect to FIG. 8.

The base station 103 may provide gas, electricity, hydrogen fuel, or another form of energy to the submersible cleaning vehicle 101. The base station 103 may generate the energy using solar panels, wind turbines, a wave-energy harvester, or another energy generator. The base station 103 may have systems for docking to and providing energy to the submersible cleaning vehicle 101. For example, the base station 103 may have an on-ship maintenance bay 151 where operators can connect charging cables to the submersible cleaning vehicle 101, change a battery of the submersible cleaning vehicle 101, change a fuel cell of the submersible cleaning vehicle 101, replenish a fuel of the submersible cleaning vehicle 101, or the like. Submersible cleaning vehicles 101 may also arrive at the maintenance bay 151 to empty their waste. Submersible cleaning vehicles 101 may couple to a computer to receive program updates at the maintenance bay. The maintenance bay 151 may support multiple submersible cleaning vehicles 101 in parallel. For example, a first submersible cleaning vehicle 101 can refill its energy reserves while a second submersible cleaning vehicle 101 dumps its waste into the waste holding area.

In some cases, the base station 103 may have systems for providing energy to the submersible cleaning vehicle 101 while the submersible cleaning vehicle 101 remains at least partially deployed in water. For example, the base station 103 may have charging ports 159 along the bottom or sides for the submersible cleaning vehicle 101 to obtain energy from. The submersible cleaning vehicle 101 may have corresponding charging ports to receive energy. For example, a submersible cleaning vehicle 101 may have charging ports at the top to receive energy from charging ports at the bottom of a boat. As another example, a submersible cleaning vehicle 101 may have charging ports at its front, back, or sides to receive energy from charging ports at a front, back, or side of a boat. These ports may provide wired or wireless charging capabilities. The submersible cleaning vehicle 101 may dock near a port below or beside the base station 103 using a docking attachment, such as rope, hooks, a magnet and/or metal, latches, clamps, or the like when receiving energy. In examples that use gas, hydrogen fuel cells, or other form of energy supply, the port can be configured for replenishing or replacing the energy supply while the submersible vehicle is wet docked.

The base station 103 may also have communication equipment 153 for communicating with the submersible cleaning vehicle 101. The communication equipment 153 may include radio, guide-by-wire, or another receiver or transmitter. The base station 103 may also have wired interfaces for physically connecting to the submersible cleaning vehicles 101. The base station 103 may also have a radio or other form of transmitter and receiver for communicating by satellite. The base station 103 may include computer systems for coordinating the deployment of multiple submersible cleaning vehicles 101, tracking the locations and status of submersible cleaning vehicles 101, receiving updates from submersible cleaning vehicles 101, sending instructions to submersible cleaning vehicles 101, sending updates to submersible cleaning vehicles 101, and the like.

The base station also includes a waste holding area, such as a chamber, compartment, and the like. Any waste collected by submersible cleaning vehicles 101 can be moved to the waste holding area for temporary storage so that the submersible cleaning vehicles 101 can empty their filters to go and collect more waste. The collected waste can be stored in the waste holding area and later recycled or otherwise properly disposed of.

### Example Submersible Cleaning Vehicle Components

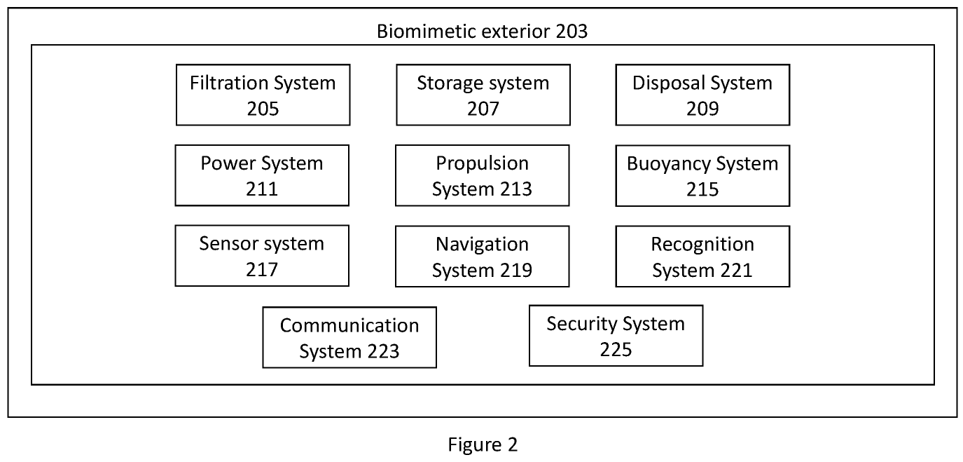

FIG. 2 shows an example submersible cleaning vehicle 101. The submersible cleaning vehicle 101 can have a biomimetic exterior 203, a filtration system 205 for collecting waste, a storage system 207 for storing waste, a disposal system 209 for disposing of collected waste, a power system 211, a propulsion system 213, a buoyancy system 215, a sensor system 217, a navigation system 219, a recognition system 221, a communication system 223, and a security system 225.

### Example Exteriors

FIG. 3 and FIG. 4 show examples of biomimetic exteriors 203. The submersible cleaning vehicle 101 can have a body, shell, skin, fabric, membrane, hull, coating, or other exterior component that appears similar to a biological creature such as a manta ray, whale, turtle, shark, or other marine creature. FIG. 3 shows an example submersible cleaning vehicle 101 with a biomimetic exterior 203A mimicking the appearance of a manta ray. FIG. 4 shows an example submersible cleaning vehicle 101 with a biomimetic exterior 203B mimicking the appearance of a whale.

In some cases, some or all of the hull of the submersible cleaning vehicle 101 can have a biomimetic shape or appearance. In other cases, even if some or all of the hull lacks a biomimetic shape or appearance, other external layers can cover some or all of the hull to create a biomimetic shape or appearance. For example, the hull can be covered by a mold, skin, fabric, or other material that mimics the appearance of a marine creature. Paint may cover the hull to mimic a color of a marine creature.

A biomimetic appearance may mimic the overall shape or structure, the presence of appendages such as fins or tails, an appearance of eyes, colors, the relative positions of physiological structures (such as the mouth, eyes, tail, fins, and gills), and the like. In some cases, the tail and fins may operate as wings or rudders for providing directional control. For a submersible cleaning vehicle 101, an opening for the filter intake can mimic a marine creature's opened mouth by shape and position. A biomimetic submersible cleaning vehicle 101 may have a larger-than-natural filter intake (e.g., a disproportionately large mouth aperture) to process a larger volume of water. Water, particles, and marine creatures that exit a filter (for example, through the sides of the filter as shown in FIG. 5) may exit at an opening in the hull that mimics a marine creature's gills, blowhole, rear, or other orifice. One or more rudders or fins may mimic the tail or fins of a marine creature.

### Example Filtration System

FIG. 5 shows an example filtration system 205 for collecting waste. The filtration system includes one or more filters 501, 503, 505. The filters may be arranged in a stacked, nested, or hierarchical configuration. Water passes in through the filter intake and travels through the one or more filters 501, 503, 505. During the filtering process, the filters may capture plastics, polymers, and other waste particles 513. Each filter may have an opening 507, a side filter 509, and a base filter 511.

The filters 501, 503, 505 may comprise materials that filter out particles of decreasing sizes. For example, the first filter 501 may have a 50 mm particle filter size, the second filter 503 may have a 5 mm particle filter size, and the third filter 505 may have a 50 μm particle filter size. In other examples, the sizes of the filters may range from centimeter-size particle filters to nanometer-size particle filters. For example, polymer microbeads may be around 10 nm in diameter, so a filtration system 205 may include a filter with a 5 nm particle filter size. In other examples, the quantity of filters may vary from just a single filter to many stages of filters, such as 5, 10, or more.

The filters 501, 503, and 505 may have different side filters and base filters. The respective side filters have filter sizes that allow particles captured by the base filters to escape. This allows for side-separation of microorganisms and other marine creatures. For example, a first filter 501 may have a base filter that captures particles larger than 1 cm and a side filter that captures particles larger than 2 cm. The second filter 503 may have a base filter that captures particles larger than 1 mm and a side filter that captures particles larger than 1 cm. The third filter may have a base filter that captures particles larger than 1 mm and a side filter that captures particles larger than 1 mm. As the submersible cleaning vehicle 101 travels through water, the flow of water pushes waste against the respective base filters. Organisms caught at a base filter may escape through larger openings in the corresponding side filter. This way, the submersible vehicle 101 provides the ability for marine creatures initially captured in the flow to the filters to escape or be ejected from the filters.

FIG. 5 illustrates filters 501, 503, 505 in an expanded view for clarity, with spacing between the filters 501, 503, 505. The filters 501, 503, 505 may also be arranged such that the filters 501, 503, 505 would be positioned with less or no separation, such that water and particles exiting through the base of one filter will enter into the opening of the next filter. Although the filters 501, 503, 505 are illustrated as conic sections, the filters may have any shape, such as sections of cylinders, spheres, prisms, ellipsoids, and the like.

FIG. 6 shows an example placement of the filters from FIG. 5 within the biomimetic submersible cleaning vehicle 101 of FIG. 4. In some designs, the biomimetic exterior 203 may have exit slots that resemble gills (not illustrated) for organisms to exit. In some designs, the biomimetic exterior may allow organisms to exit the filters, travel to the back of the biomimetic exteriors 203, and then exit through the rear of the biomimetic exterior.

Larger filters may improve the efficiency of collecting waste. As a result, one or more of the filters 501, 503, 505 may have a cross-sectional area, when viewed from the front (in the direction of intake), that is at least 10%, 20%, 25%, 30%, 40%, 50%, 60%, 70%, 75%, 8″ or 90% of the hull.

### Example Storage System

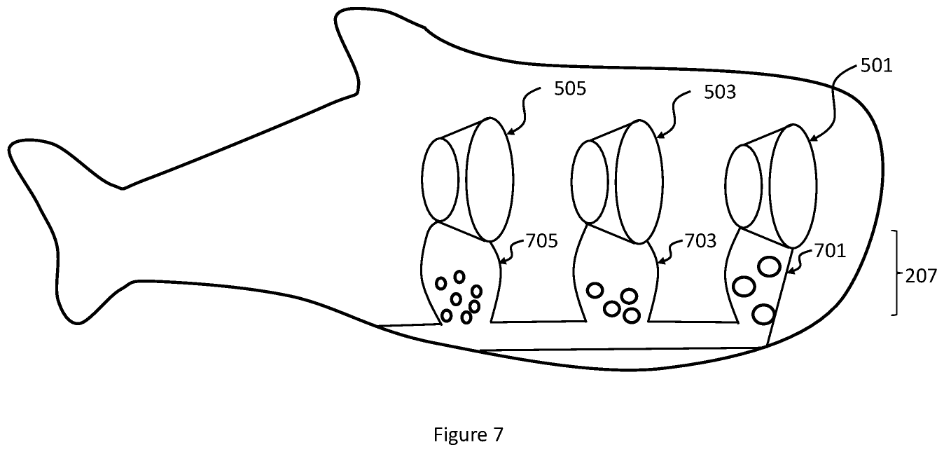

FIG. 7 shows an example storage system 207. The storage subsystem includes storage containers 701, 703, 705.

Each storage container 701, 703, 705 is positioned to receive waste from respective filters 501, 503, 505. In other embodiments, a single larger storage container can take the place of multiple respective storage containers. As the filters collect waste, the waste can move into the storage containers to prevent the filters from clogging up. In the illustrated example, gravity causes the waste to fall through an opening in the filters. In some embodiments, a suction or pressure can force waste from the filters into one or more storage containers. The storage containers can be made of a durable, nonporous material, such as metal, plastic, or the like so that collected waste does not escape. The storage containers can have a volume larger than the volume of the filters.

### Example Surfacing Container

FIG. 8 shows an example system with a surfacing container 801. A filtration system, such as filtration system 205 of FIG. 2, may use surfacing container 801, such as shown in FIG. 8, that eject, deploy to the surface and allow for location and retrieval by a surface vehicle, such as a boat. Additionally, or alternatively, a storage system, such as storage system 207 of FIG. 2, may use surfacing containers 801. The surfacing containers 801 can separate from the submersible cleaning vehicle 101 and float to the surface for collection after filling with waste. The surfacing containers 801 includes a container 803, an opening 804, seal 805 for sealing up the opening 804, a flotation ring 807, a control system 809, one or more beacons 811, and a second sealer 813.

The container 803 may comprise a filter material, such as those described above with respect to FIG. 2. The filter material allows water to exit the container 803 while retaining plastic and/or polymer waste of various particle sizes. Alternatively, the container 803 may comprise an impermeable material, such as metal or plastic, such as those described above with respect to FIG. 7.

The sealing 805 may close up in order to prevent waste from exiting the opening 804 of the surfacing container 801. The sealing 805 may be implemented, for example, with a drawstring, Velcro, latching flaps, aligning and misaligning orifices, a zipper, a press seal, a sliding seal, and the like. The sealing 805 may remain open while performing cleaning operations, and the sealing 805 may close before sending the surfacing container 801 for collection.

The flotation ring 807 sends the surfacing container 801 to the surface for collection. Due to buoyancy, the inflatable flotation ring 807 will cause the surfacing container 801 to rise and remain on the surface of the water. The flotation ring 807 may be made of a floating foam, materials used in life vests and lifesavers, wood, or other floating materials including certain plastics. In some embodiments, the floatation ring 807 may be an inflatable flotation ring that inflates when the surfacing container is ready for sending to the surface for collection. Inflatable floatation rings 807 may include, for example, an inflatable balloon or bladder.

A control system 809 includes a power source, a controller, and an actuator. The power source may be a battery, a capacitor, and the like. The components of the control system 809 may reside in a protective box or compartment coupled to the container 803. The power source provides energy to the controller and to the actuator. The controller can be a processor, microprocessor, FPGA, ASIC, and the like. The controller may be configured to execute instructions stored on a nonvolatile storage medium. The controller is configured to, at the appropriate time, transmit a first signal to cause the sealing opening 805 to seal and then transmit a second signal to cause the inflatable flotation ring 807 to inflate. An actuator may receive the first signal and, in response, cause the sealing opening 805 to seal. For example, in systems where a drawstring closes the sealing opening 805, the actuator may windup the drawstring. In systems where a zipper closes the sealing opening 805, the actuator may similarly pull a zipper to close the sealing opening 805. In some examples, the control system 809 can couple to the surfacing container 801 and surface with the surfacing container 801. In some examples, the control system 809 can couple to the submersible cleaning vehicle 101 and remain in the submersible cleaning vehicle 101 while the surfacing container 801 surfaces.

The control system 809 can control the operation of the surfacing container 801 at appropriate times. For example, the control system 809 may trigger inflation once the filter or container is full or collected a designated amount of waste. As another example, the control box 809 may trigger inflation once a submersible underwater cleaning vehicle 101 has finished cleaning a route; reached a location; finished cleaning an area, such as by detecting that no new waste has been collected in the filter or container after cleaning for a first amount of time; cleaning for a second amount of time; reached a proximity to a collection location such a boat, harbor, rig, or other infrastructure capable of collecting storage containers; or received an instruction to send the waste for collection. The inflation trigger may be activated by control box 809 to cause the inflatable flotation ring 807 to cause the surfacing container 801 to rise and remain on the surface of the water. The control box may activate one or more of the location beacons 811 upon ejection from the submersible cleaning vehicle or upon surfacing.

One or more location beacons 811 may provide location information ab out the surfacing container 801. The location beacons 811 can include for example, a passive location beacon and/or an active location beacon. The beacons 811 may facilitate collection of the surfacing container 801, such as once the surfacing container 801 has risen to the surface of the water. For example, an active location beacon 811 can draw energy from a battery or other power source to send radio frequency signals or pings to broadcast its location. As another example, an active location beacon 811 can draw energy to blink or send flashes of light to enable easy visual identification at night. A passive location beacon 811 is not coupled to an energy reserve. Other examples of locator beacons include personal locator beacons and satellite messengers.

A second sealer 813 may assure that the waste remains in the surfacing container 801 under adverse weather conditions. The second sealer 813 moves to block the opening 804. The control system 809 can move the second sealer 813 to block or unblock the opening, for example, via an actuator. The second sealer 813 can be, for example, a metal or plastic lid, a rubber stopper, and the like.

### Example Disposal System

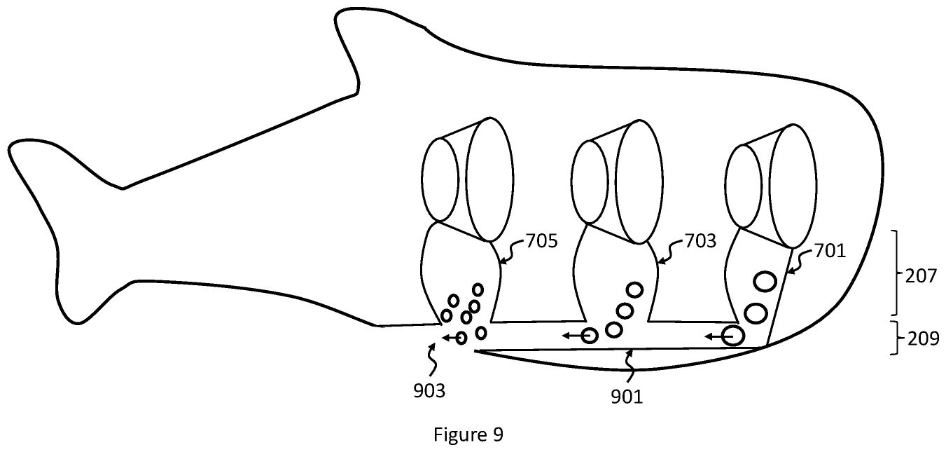

FIG. 9 shows an example disposal system 209. An extraction pathway 901 couples the storage containers 701, 703, 705 to an exit 903. When the submersible cleaning vehicle is docked, an extraction system can connect to the exit 903 and use a vacuum or suction force to empty the storage containers. During extraction, the exit 809 opens, and the waste particles move in the illustrated direction, toward the exit. In some embodiments, the exit may be at the bottom so that gravity facilitates extraction of waste. In other embodiments, the exit may be at the top, sides or other position.

### Example Propulsion System

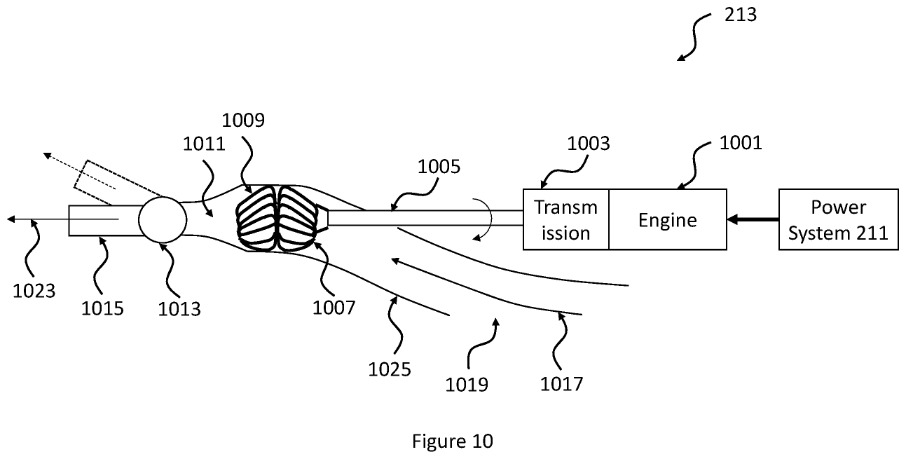

FIG. 10 shows an example propulsion system 213. The propulsion system can include a power source storing energy, an engine to convert the stored energy into kinetic energy, and a rotor turned by the engine to propel water. As illustrated, the propulsion system includes an impeller. Some propulsion systems 213 may use propellers, water-jet propulsion, and the like. Some propulsion systems 213 may use actuators, hydraulics, and the like to move fins, tails, flaps, and other parts of the biomimetic exterior 203 illustrated in FIG. 3 and FIG. 4 to move in ways that mimic aquatic life.

As illustrated, the example propulsion system 213 includes an engine 1001 that receives energy from the power system 211, a transmission box 1003, a shaft 1005, impeller blades 1007, a stator 1009, a volume reducing nozzle 1011, a pivot 1013, and an exhaust port 1015. Entering water 1017 enters an intake pipe 1021 through an intake area 1019. Exiting water 1023 exits and propels out the exhaust port 1015.

The power system 211 delivers power to the engine 1001, which may be a motor, a turbine, or the like. Kinetic energy generated by the engine may couple through gears in a transmission box 1003 to drive a shaft 1005 coupled to impeller blades 1007. The intake area 1019 may have a filter to prevent marine creatures from entering. As entering water 1017 enters through the intake area 1019, the water flows past the impeller blades 1007, which turn to move the water faster to generate propulsion. The water then flows past a stator 1009 to improve efficiency into the volume reducing nozzle 1011. By decreasing the volume through which the water flows, the water flows at a faster rate. The exiting water 1023 then exhausts through the exhaust port 1015. The angle of the exhaust port 1015 can change like a rudder, for example, about a pivot 1013, to control the direction of propulsion.

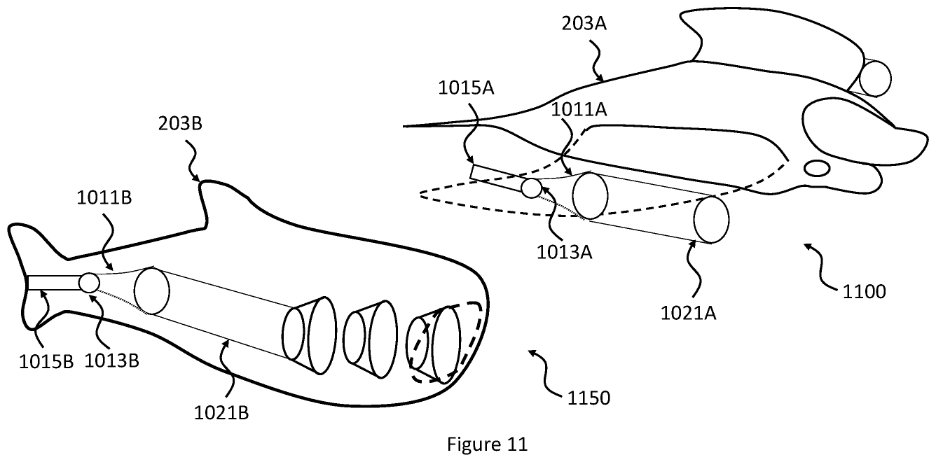

FIG. 11 shows two examples of propulsion systems 213 coupled to biomimetic exteriors 203A, 203B.

In a first example 1100, the intake pipe 1021A, volume reducing nozzle 1011A, pivot 1013A, and exhaust port 1015A couple to the wings outside the biomimetic exterior 203A, similar to the position of turbines on an airplane.

In a second example 1150, the intake pipe 1021B, volume reducing nozzle 1011A, pivot 1013A, and exhaust port 1015A couple inside the biomimetic exterior 203B. The intake pipe 1021B couples to receive water passing through a filter. This position of the intake pipe 1021B to receive water from the filters can increase the volume of water processed by the filters, and the filters can prevent marine creatures from entering the intake pipe 1021B.

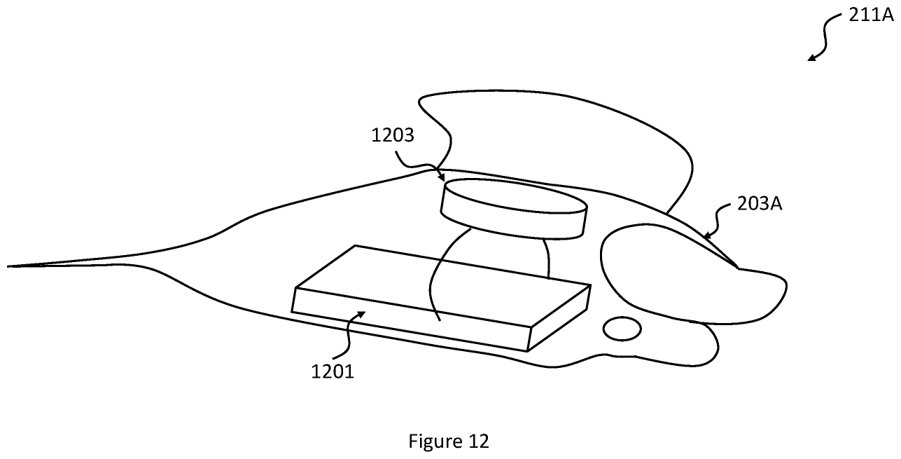

FIG. 12 shows an example power system 211 in the biomimetic exterior 203A, with one wing removed to better illustrate the internal components. The power system 211 includes a battery 1201 electrically coupled to a wireless charge receiver 1203, such as an inductive coil. The power system 211 may provide power to any or all components of the submersible cleaning vehicle 101.

A magnetic field passes through the wireless charge receiver 1203 to induce current to the battery 1201. Any electrical components, such as the battery 1301 and wireless charge receiver 1203, may reside in waterproof compartments. A wireless charge receiver permits for a greater variety of waterproof compartment designs with reduced need for physical access.

Positioning the wireless charge receiver 1203 near the top of the hull allows the submersible cleaning vehicle 101 to dock below a base having a wireless charger to charge the battery 1201 through the wireless charge receiver 1203. In other designs, a charge receiver may be positioned near the front, sides, back, or bottom of the submersible cleaning vehicle 101. For example, a charge receiver at the side of the submersible cleaning vehicle 101 allows the submersible cleaning vehicle 101 to receive charge while docked beside a base.

In other designs, the charge receiver may be a wired charge receiver. For example, the submersible cleaning vehicle 101 may be dry docked before accessing the ports to charge the battery.

In other designs, the power system 211 may receive various forms of energy. For example, the power system may use lithium-ion batteries, hydrogen fuel cells, gas, diesel, and the like and any hybrid thereof. The energy supply may be replaced or replenished while the submersible vehicle remains at least partially submerged.

### Example Buoyancy System

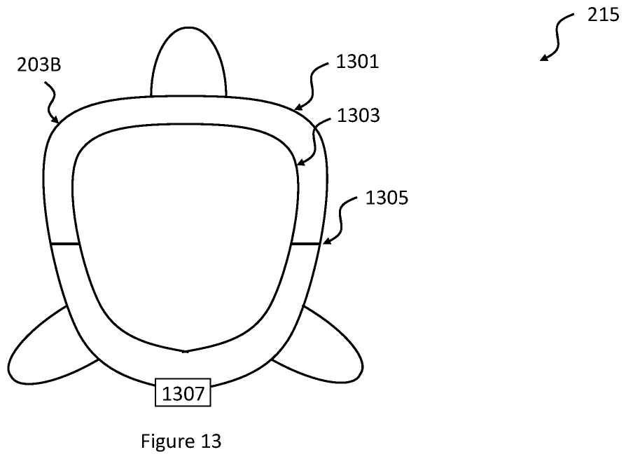

FIG. 13 shows an example buoyancy system 215. FIG. 13 shows a front profile view cutaway of the biomimetic exterior 203B mimicking the appearance of a whale. An exterior wall 1301 is spaced apart from the interior wall 1303, and the cavity therebetween forms a ballast tank. A pump 1307 pumps water in or out to raise or lower the water line within the tank 1305, thereby adjusting the buoyancy. The buoyancy system may operate with or without an air reserve for filling the ballast tank when the water is pumped out. In some systems, ballast tanks separate from the hull may be used. Other example buoyancy systems may include a bladder-based system that expands or contracts a bladder to control buoyancy.

### Example Electrical Components

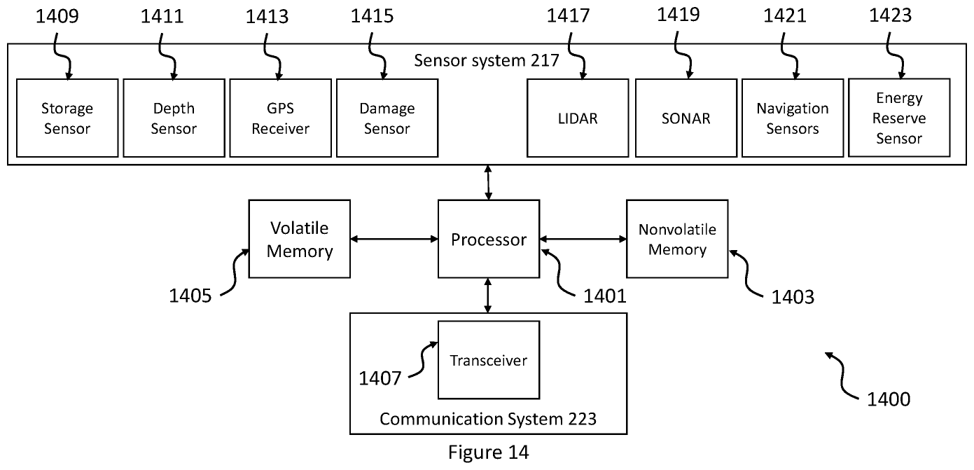

FIG. 14 shows an example electrical component system 1400. The electrical component system may receive power from the power system 211. The electrical component system includes a processor 1401, nonvolatile memory 1403, volatile memory 1405, a sensor system 217, and a communication system 223. The communication system 223 includes one or more transceivers 1407. The sensor system 217 includes one or more storage sensors 1409, depth sensors 1411, a GPS (global positioning system) receiver 1413, a damage sensor, a lidar (light detection and ranging) sensor 1417, a SONAR (sound navigation and ranging) 1417, navigation sensors 1421, and energy reserve sensors 1423. The electrical component system 1400 may be kept in one or more waterproof compartments in the submersible cleaning vehicle 101. In some systems, other sensors can include radar, cameras, and the like.

The nonvolatile memory 1403 stores computer-readable instructions. The nonvolatile memory 1403 and/or the volatile memory 1405 can also store data, such as data collected from the sensor system 217 and/or data received through the communication system 223. The processor 1401 is configured to execute the computer-readable instructions to operate and manage the submersible cleaning vehicle 101. The processor 1401 may be a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), or any suitable combination thereof. The term “processor” includes multicore processors that may comprise two or more independent processors (sometimes referred to as “cores”) that may execute instructions contemporaneously.

The communication system 223 includes a transceiver 1407, which may be a radio, satellite phone, physical wire or bus, or another transmitting and receiving device. The transceiver 1407 may communicate with base stations, other submersible cleaning vehicles 101, satellites, ships, or the like. The transceiver 1407 can transmit data such as status information, data from any sensor of the sensor system 217, and the like. The status information can include, for example: battery life remaining, battery condition, battery voltage, power reserve of the power source, filter presence, quantity of waste collected in filters or storage, depth of the submersible cleaning vehicle 101, coordinates or other position information about the submersible cleaning vehicle 101, damage taken by the submersible cleaning vehicle 101, direction of the submersible cleaning vehicle 101, orientation of the submersible cleaning vehicle 101, speed of the submersible cleaning vehicle 101, rate of waste collection, sonar data, lidar data, topological or other map data, task completion percentage, and other forms of data.

The storage sensors 1409 may sense the presence of the filters and/or an amount of waste collected by filters. If waste is stored in the filters, then the storage sensors 1409 may detect the weight of the filters or the drag of the filters, with greater weight and/or drag indicating that the filters have collected more waste. If waste is stored in another storage compartment, then the storage sensors 1409 may detect the mass of the storage compartment, the volume of waste in the storage compartment, and the like.

The depth sensor 1411 may sense a depth of the submersible cleaning vehicle 101. Data from the storage sensors 1409 and data from the depth sensor 1411 can be combined to identify which depths have more waste. This information can be used to optimize cleaning by the submersible cleaning vehicle 101 and/or other submersible cleaning vehicles. For example, submersible cleaning vehicles 101 can spend more time cleaning at depths that are comparatively dirtier than other depths. The submersible cleaning vehicle may detect that an area is dirtier if its filters or storage fills up faster.

A GPS receiver 1413 can receive GPS signals to determine a position. A submersible cleaning vehicle 101 can periodically surface and receive GPS signals. A processor can use the GPS information to determine the location of the submersible cleaning vehicles 101, to adjust the course of the submersible cleaning vehicles 101, and the like. A processor can also use the GPS information to detect, for example, whether the submersible cleaning vehicles 101 are off course. Detecting that the submersible cleaning vehicles 101 have surfaced and are positioned off course may indicate malfunction or theft.

A damage sensor 1415 can detect damage to or pressure against the hull. For example, a pressure sensor on the hull may detect pressure indicating events such as a marine creature biting the submersible cleaning vehicle 101, collisions with other objects, and the like.

A lidar sensor 1417 can use light to recognize objects, terrain, waste, and the like. Data from the lidar sensor 1417 can be processed with image recognition software or artificial intelligence systems to detect objects, terrain, waste, and the like. The submersible cleaning vehicle 101 can avoid colliding with objects, avoid colliding with terrain, and collect identified waste in the filters. For example, in response to detecting a school of fish in a first area to be cleaned, a submersible cleaning vehicle 101 may clean a second area away from the school of fish and later return to clean the first area after the fish have departed. As another example, in response to detecting a rock cliff, the submersible cleaning vehicle 101 may navigate around or over the rock cliff while cleaning an area. As another example, in response to detecting numerous pieces of waste in an area, the submersible cleaning vehicle 101 may repeatedly clean the area until the pieces of waste are collected before moving on to a next area.

A SONAR sensor 1419 can use light to recognize objects, terrain, waste, and the like. Data from the SONAR sensor 1419 can be processed with recognition software or artificial intelligence systems to detect objects, terrain, waste, and the like. The submersible cleaning vehicle 101 can avoid colliding with objects, avoid colliding with terrain, and collect identified waste in the filters. Sonar data may be used in place of or combined with lidar data.

The navigation sensors 1421 can include one or more of a magnetometer/compass, gyroscope, accelerometer, speedometer, orientation sensor, and the like. These navigation sensors 1421 can individually or collectively detect a direction, speed, acceleration, and position of the submersible cleaning vehicle 101. The navigation sensors 1421 may collect data used to perform dead reckoning calculations to track the three-dimensional path taken by the submersible cleaning vehicle 101, even while submerged, using kinematic principles.

The energy reserve sensor 1423 can provide data about the energy reserves. For example, in a battery-powered submersible cleaning vehicle 101, the energy reserve sensor can be coupled to the battery and provide data indicating one or more of: the quantity of charge left in the battery, the temperature of the battery, the voltage of the battery, the rate of energy use, the quantity of current to or from the battery, and the like. Corresponding versions of these data can be collected for other types of energy reserves (fuel cell, gas, diesel, etc.).

### Example Navigation

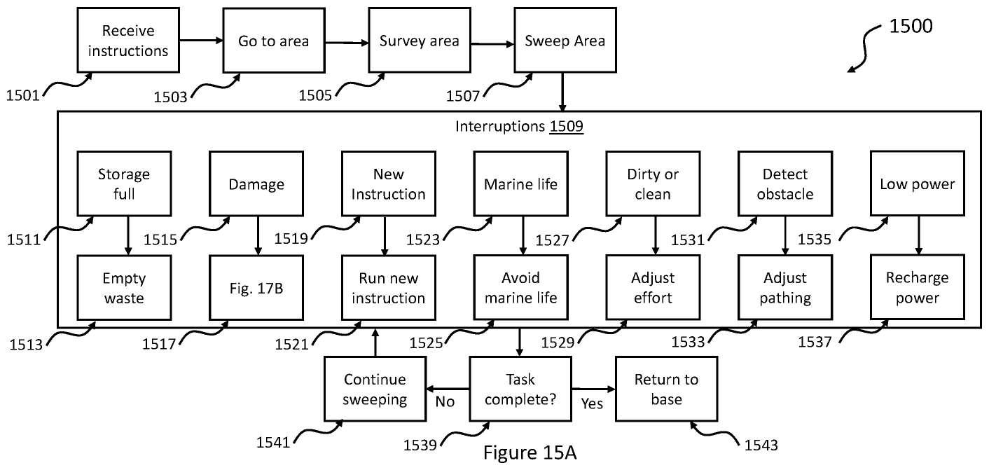

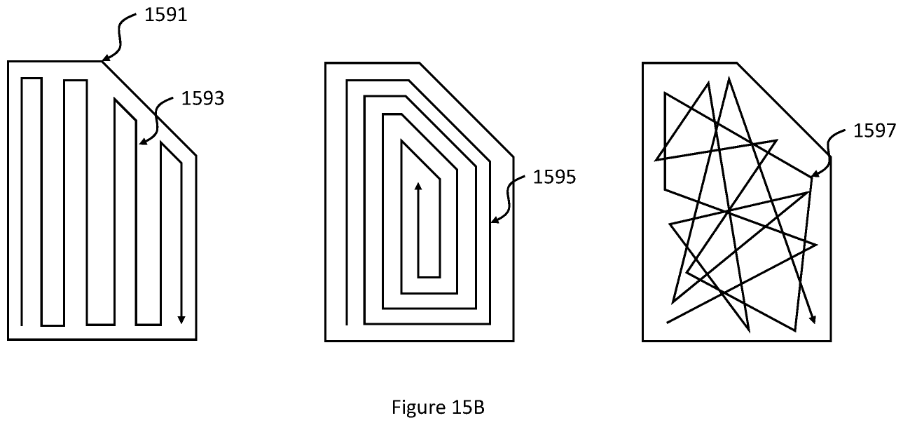

FIG. 15A shows a flowchart 1500 of instructions for navigating a submersible cleaning vehicle 101. At block 1501, the submersible cleaning vehicle 101 can receive instructions. The instructions may direct the submersible cleaning vehicle 101 to clean a target area of water. The target area may be a two- or three-dimensional area. In some cases, the target area may be defined as a set of coordinates that outline a geofence. In some cases, the submersible cleaning vehicle 101 can receive additional data, such as map data, terrain data, topology data, locations of waste, and the like. The instructions may direct the submersible cleaning vehicle 101 to clean the target area until a sweep is completed or to clean for a set amount of time until a certain quantity of waste is collected, until a rate of waste collection is reached (e.g., less than a certain amount of waste per time unit), or another condition. The instructions and any data may be received through the communication system 223, processed by the processor 1401, and stored in either volatile memory 1405 and/or nonvolatile memory 1403 for execution.

At block 1503, the submersible cleaning vehicle 101 may travel to the target area of water specified in the instructions. The submersible cleaning vehicle 101 can use its sensors, including the GPS receiver 1413, sonar 1419, lidar 1417, and navigation sensors 1421 (e.g., as shown in FIG. 14), to gather data and determine the position of the target area relative to the submersible cleaning vehicle 101. The submersible cleaning vehicle 101 can then use its propulsion system to travel to the target area.

Upon reaching the target area, the submersible cleaning vehicle 101 may then survey the target area 1505. Surveying may include collecting sonar data, lidar data, depth data, and the like. The collected data can be used to identify obstacles and marine life in the area, which can be avoided when sweeping.

At block 1507, the submersible cleaning vehicle 101 can begin sweeping the target area. As the submersible cleaning vehicle 101 sweeps the target area, the submersible cleaning vehicle 101 collects waste in its filters. FIG. 15B, discussed further below, shows example sweep routes. As the submersible cleaning vehicle 101 sweeps the target area, the submersible cleaning vehicle 101 may encounter an interruption 1509 and respond appropriately.

At block 1539, it can be determined whether the task is complete. For example, if instructed to sweep a target area, the submersible cleaning vehicle 101 can determine whether it completed its route. If instructed to sweep a target area for a set duration, then the submersible cleaning vehicle 101 can determine that it completed cleaning for the set duration.

In response to completing the task, the submersible cleaning vehicle 101 can return to base at block 1543. The submersible cleaning vehicle 101 can use its sensors, including the GPS receiver 1413, sonar 1419, lidar 1417, and navigation sensors 1421 (e.g., as shown in FIG. 14), to gather data and determine the position of the base relative to the submersible cleaning vehicle 101. The submersible cleaning vehicle 101 can then use its propulsion system to travel to the base.

If the task remains uncompleted, the submersible cleaning vehicle 101 may continue sweeping the area at block 1541 and handling any interruptions 1509.

The submersible cleaning vehicle 101 may respond to a number of interruptions while sweeping an area. For example, at block 1511, the submersible cleaning vehicle 101 may detect that its waste storage is full. The submersible cleaning vehicle 101 may determine that its waste storage is full when data from the storage sensor 1409 indicate that the stored waste exceeds a threshold quantity. In response, the submersible cleaning vehicle 101 may empty its waste at block 1513. The submersible cleaning vehicle 101 may return to a base station to have any collected waste transferred into a waste holding area (e.g., as illustrated in FIG. 1). The submersible cleaning vehicle 101 may alternatively send the collected waste in a surfacing container 801 to the surface for collection (e.g., as described with respect to FIG. 8).

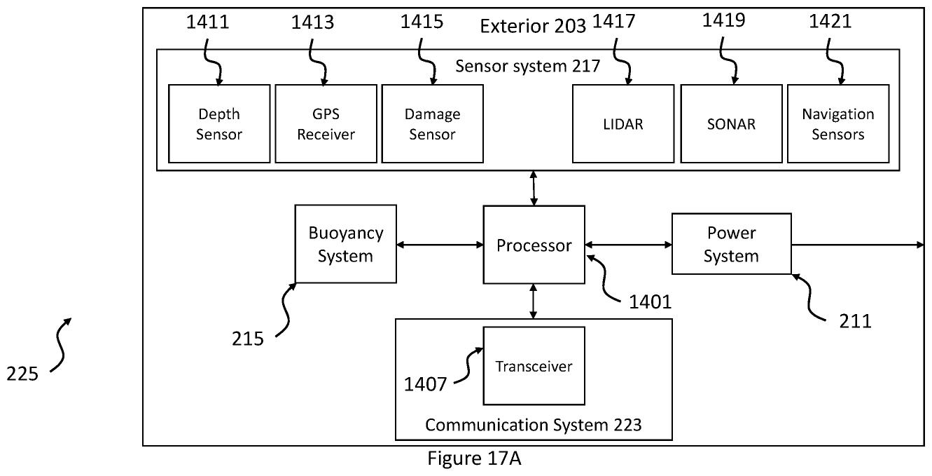

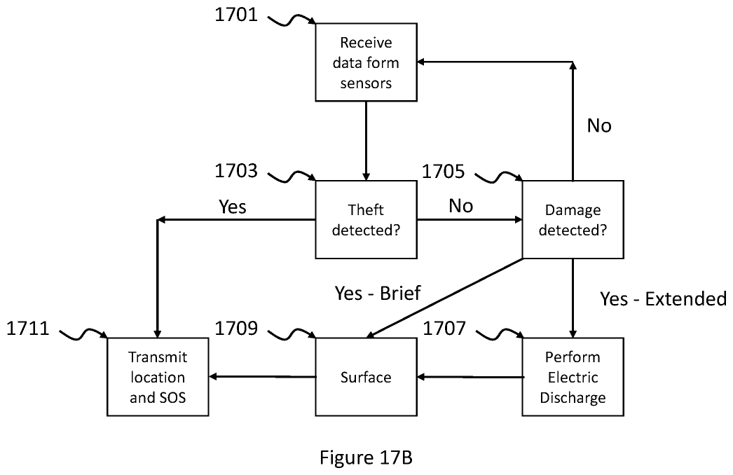

If the submersible cleaning vehicle 101 receives damage at block 1515, then at block 1517, the submersible cleaning vehicle 101 may respond as further described with respect to FIG. 17B.

If the submersible cleaning vehicle 101 receives new instructions at block 1519, then the submersible cleaning vehicle 101 can run the new instructions at block 1521. For example, the submersible cleaning vehicle 101 may receive, via the communication system 223, instructions to clean a new target location. The submersible cleaning vehicle 101 may then suspend or override the present task with the new task.

If the submersible cleaning vehicle 101 detects nearby marine life at block 1523, then at block 1525, the submersible cleaning vehicle 101 can avoid the marine life. The marine life can be detected, for example, based on data from the sonar and lidar. Additionally, or alternatively, a submersible cleaning vehicle 101 may receive, via the communication system 223, messages indicating the locations of marine life. In response, the submersible cleaning vehicle 101 may avoid moving near the location of marine life. For example, the submersible cleaning vehicle 101 may clean other parts of the target area away from the marine life. As another example, the submersible cleaning vehicle 101 may first clean a different target area in queue and later return to clean the original target area after the marine life leaves.

If a submersible cleaning vehicle 101 determines that the dirtiness or cleanness of an area deviates from an expected range at block 1527, then at block 1529, the submersible cleaning vehicle 101 can adjust the cleaning effort. For example, the submersible cleaning vehicle 101 may receive and use lidar data to count a quantity of waste particles. The submersible cleaning vehicle 101 may additionally or alternatively use data from its storage sensor 1409 to determine how quickly waste is being collected. If either the quantity of waste particles or the rate of waste collection exceeds a respective dirtiness threshold, then the submersible cleaning vehicle 101 may make a greater effort to clean the target area. For example, the submersible cleaning vehicle 101 may slow down the travel speed, clean the target area more than once, or send messages via the communication system 223 indicating that the target area is dirty and/or requesting additional submersible cleaning vehicles 101 to clean the target area. If either the quantity of waste particles or the rate of waste collection is less than a respective dirtiness threshold, then the submersible cleaning vehicle 101 may reduce the effort of cleaning the target area. For example, the submersible cleaning vehicle 101 may speed up, make fewer passes, and the like.

If a submersible cleaning vehicle 101 detects an obstacle at block 1531, then at block 1533, the submersible cleaning vehicle 101 may adjust its pathing to go around, over, or beneath the obstacle. The submersible cleaning vehicle 101 may collect sonar and lidar data to identify obstacles.

If a submersible cleaning vehicle 101 detects that its power reserves fall below a threshold reserve value, then at block 1537, the submersible cleaning vehicle 101 may suspend its task to return to a base station to refill its power reserve. For example, the submersible cleaning vehicle 101 may recharge its battery, replace its fuel cell, refill gasoline, or the like. In some cases, the submersible cleaning vehicle 101 may dock with the base station and recharge a battery using a wireless charger while remaining at least partially submerged. After refilling its power reserve, the submersible cleaning vehicle 101 may return to sweeping the target area.

FIG. 15B shows three example sweeping paths 1593, 1595, 1597 for a submersible cleaning vehicle 101 in an area 1591. The area 1591 is shown as a two-dimensional area, but the techniques extend to three dimensional areas. The first path 1593 goes up and down columns to cover the area 1591 and includes moving to a next column at the top or bottom. The second path 1595 takes the form of a spiral. The third path 1597 is a random path. Other variations include the reversed paths, rotated paths, combinations of any techniques, and the like. The paths may be repeated or extend to three dimensions. For example, a submersible cleaning vehicle 101 may randomly navigate around three dimensions in an area 1591.

### Example Recognition System

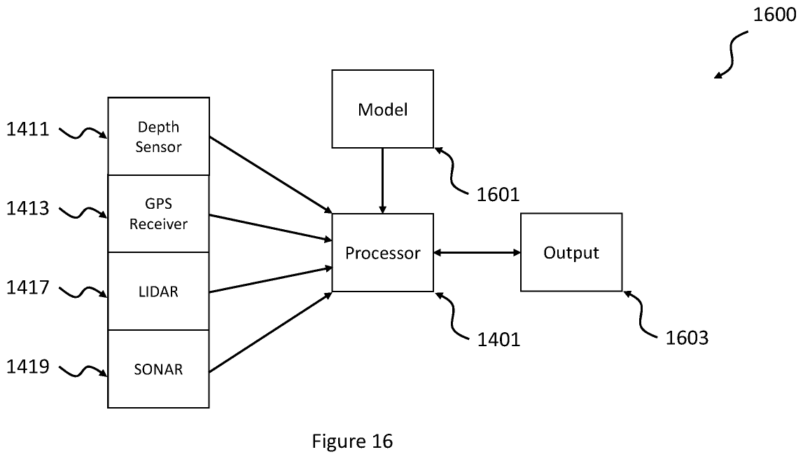

FIG. 16 shows an example recognition system 1600. The recognition system 1600 includes a processor 1401 and a model 1601. Sensor data, such as depth sensor 1411 data, GPS receiver data 1413, lidar 1417 data, and sonar 1419 data, are provided to the processor 1401. The processor 1401 processes the data using one or more object recognition models 1601. Then, the processor 1401 generates an output 1603 that recognizes objects based on the data according to the model 1601.

For example, data indicating large, stationary objects at depths may be recognized as rocks, walls, or other topological features. Data indicating smaller, mobile objects may be recognized as marine creatures. Data indicating mobile objects at surface level may be recognized as marine creatures or boats, depending on size and speed.

### Example Security System

FIG. 17A shows an example security system 225. The security system may include previously described components including: the exterior 203, power system 211, buoyancy system 215, processor 1401, communication system 223, and sensor system 217. The sensors in the sensor system 217 can include the depth sensor 1411, GPS receiver 1413, damage sensor 1415, lidar sensor 1417, sonar sensor 1719, and navigation sensors 1421.

The processor 1401 is configured to receive data from the sensor system 217 to detect security events, such as theft or damage. In response, the processor 1401 can send commands to cause the power system 211 to deliver a high voltage electric shock through the exterior 203 and/or to cause the submersible cleaning vehicle 101 to broadcast its location with an SOS-type message. The processor can execute instructions stored on a non-transitory, computer-readable storage medium in accordance with the process shown in FIG. 17B.

FIG. 17B shows an example flowchart 1700 of a security process. At block 1701, data from sensors can be received. The data can include depth data, GPS data, damage data, lidar data, sonar data, and navigation data.

At block 1703, the data can be analyzed to determine whether a theft has occurred. For example, a theft can be determined if the data from the sensors indicate that the submersible cleaning vehicle 101 is moving other than expected. For example, the depth data can be compared to an expected depth. A discrepancy in the depth, especially if the submersible cleaning vehicle 101 is out of the water, when it should be in the water cleaning, indicates theft. Also, the GPS data and/or navigation data can be used to determine a location, which can be compared against an expected location. For example, it can be determined that a theft has occurred if the submersible cleaning vehicle 101 was programmed to clean a first area but sensor data indicate that the submersible cleaning vehicle 101 is moving away from the first area.

If a theft is detected at block 1703, then the submersible cleaning vehicle 101 can proceed to block 1711 to transmit its location and an SOS-type message can indicate that the submersible cleaning vehicle 101 is being stolen or needs help. This transmission facilitates tracking down and retrieving the submersible cleaning vehicle 101. The location can be broadcast by radio, satellite phone, or any other transmitter.

If a theft is not detected at block 1703, then at block 1705, the data can be analyzed to determine whether damage occurred and, optionally, what type of damage. If no damage is detected, then block 1705 can proceed back to block 1701 to continue monitoring for security events. If a brief damage event is detected, then block 1705 can proceed to block 1709. If an extended damage event is detected, then block 1705 can proceed to block 1707.

A damage event may be detected, for example, based on data from the damage sensor indicating pressure against the hull. For example, a pressure sensor on the hull may detect pressure indicating events such as a marine creature grabbing orbiting the submersible cleaning vehicle 101, collisions with other objects, and the like. A damage event may also be detected, for example, based on an accelerometer registering a sudden shock or based on navigation sensors 1421 indicating that a force is being applied to the submersible cleaning vehicle 101. A damage event may be classified as a brief or extended event by comparing the duration of the damage event to a threshold time. A brief damage event suggests a collision. An extended damage event suggests that another marine creature may be attempting to bite, eat, or grab the submersible cleaning vehicle 101.

At block 1707, in response to detecting an extended duration damage event, the submersible cleaning vehicle 101 may perform an electric discharge. Performing an electric discharge can include, for example, coupling the power system 211 to the exterior 203. To deliver a short, high-voltage discharge, one or more capacitors or other similar energy storage devices can store energy from the power system. Then, a discharge pathway from the capacitor can couple the capacitor to the exterior 203, delivering a sudden, high-voltage shock that may cause an attacking marine creature to leave the submersible cleaning vehicle 101 alone.

At block 1707, in response to detecting a short or a long duration damage event, the submersible cleaning vehicle 101 may surface. A command to surface can take priority over and override pending programs for cleaning an area of water. Surfacing allows people to find, rescue, and inspect the submersible cleaning vehicle 101 more easily. To surface, the processor 1401 can send a command to the buoyancy system 215. In some cases, the processor 1401 can additionally or alternatively send commands to the propulsion system 213 to propel the submersible cleaning vehicle 101 to the surface.

At block 1711, the submersible cleaning vehicle 101 can transmit its location information and an SOS-type (save our ship) signal. For example, the submersible cleaning vehicle 101 can transmit its location information based on GPS information received, or the submersible cleaning vehicle 101 can transmit its location information based on information calculated according to a dead reckoning technique. The submersible cleaning vehicle 101 may transmit the information by radio, satellite phone, or any other communication transmitter. The SOS-type message may include the standard SOS message, a mayday message, any help message, and the like.

### Example Deployment System

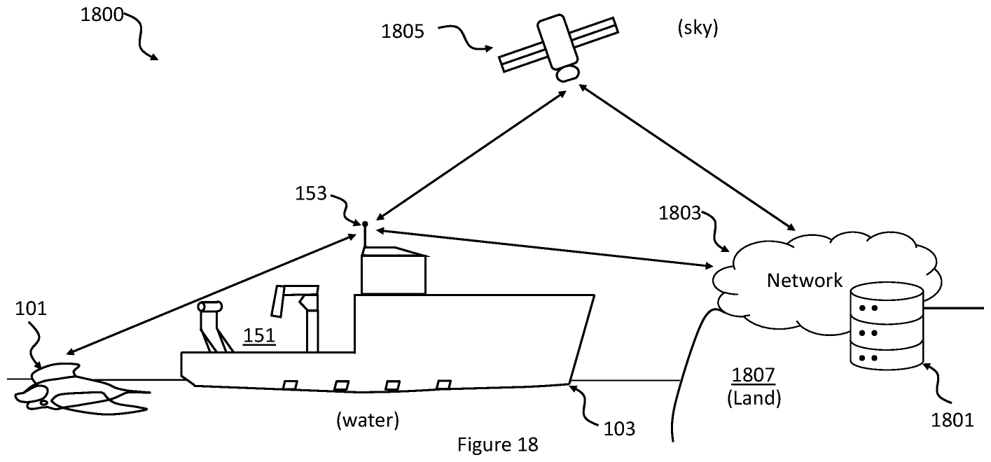

FIG. 18 shows an example of a system 1800 for directing submersible cleaning vehicles 101. The system 1800 includes a plurality of submersible cleaning vehicles 101 and the base station 103, as described in FIG. 1. On land 1807, a server 1801 communicates through a communication network 1803 to coordinate the deployment of submersible cleaning vehicles 101. A satellite 1805 may facilitate communications with land-based networks 1803. Although FIG. 18 shows a land-based server 1801, other systems may deploy servers 1801 elsewhere. Although FIG. 18 shows a satellite 1805 mediating communications between the network 1803 and the base station 103, in other systems, the base station may communication with the network 1803 without the satellite 1805.

The submersible cleaning vehicles 101 can use their sensors to collect data. The collected data include status information, such as location, collected waste, energy remaining, and the like, including any data derived therefrom, such as locations with high densities of waste. The collected data may also include sonar and lidar data and any data derived therefrom, such as map or topology information, the locations of obstacles, the locations of marine creatures, and the like. Any data from sensors and/or data derived therefrom can be communicated to the base station 103.

The base station 103 can collect data from a plurality of submersible cleaning vehicles 101. The base station 103 can send the collected data via a network 1803 and, optionally, with satellite 1805 communications, to the server 1801. The base station communicates using the communication equipment 153 discussed above with respect to FIG. 1.

The server 1801 can analyze the collected data to perform a variety of analyses. For example, the server 1801 can use the location, sonar, and lidar data to generate aggregated maps of an area. The server 1801 can identify, based on the lidar data, waste collection data, and location data, which locations are the dirtiest. In response, the server 1801 can send new instructions to deploy submersible cleaning vehicles 101 to the dirtier locations and away from cleaner locations. The server 1801 can also identify and respond to objects moving through the water. For example, the server can identify that a group of marine creatures moved through a first location near a submersible cleaning vehicle 101 toward a second location where a second submersible cleaning vehicle 101 is deployed. In response, the server can instruct the second submersible cleaning vehicle 101 to hide or relocate. The data analysis performed by the server can be augmented in view of other information, such as weather information and human input Image, lidar, sonar, and radar data can be used to identify threats, other boats, people, marine creatures, thieves, and the like. Data about threats, thieves, and illegal activities may be forwarded to proper authorities. Data about marine creatures may be forwarded to conservationists, biologists, and the like.

The server 1801 can send instructions to coordinate the deployment of submersible cleaning vehicles 101 to the base station 103. The base station 103 can update the submersible cleaning vehicles 101 with these instructions. The server 1801 can also send program updates, including updates to AI models, to the base station 103. The base station 103 can then update the programs and AI models in the submersible cleaning vehicles 101.

Additional Disclosure

Any of the principles and advantages discussed herein can be applied to other systems, not just to the systems described above. Some embodiments can include a subset of features and/or advantages set forth herein. The elements and operations of the various embodiments described above can be combined to provide further embodiments. The acts of the methods discussed herein can be performed in any order as appropriate. Moreover, the acts of the methods discussed herein can be performed serially or in parallel, as appropriate. While circuits are illustrated in particular arrangements, other equivalent arrangements are possible.

Any of the principles and advantages discussed herein can be implemented in connection with any other systems, apparatus, or methods that benefit could from any of the teachings herein.

The various illustrative blocks and processes described herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, microcontroller, state machine, combinations of the same, or the like. A processor may also be implemented as a combination of computing devices, e.g., a combination of a DSP and a microprocessor, a plurality of microprocessors or processor cores, one or more graphics or stream processors, one or more microprocessors in conjunction with a DSP, or any other such configuration.

Further, certain implementations of the present disclosure are sufficiently mathematically, computationally, or technically complex that application-specific hardware (e.g., FPGAs or ASICs) or one or more physical computing devices (utilizing appropriate executable instructions) may be necessary to perform the functionality, for example, due to the volume or complexity of the calculations involved or to provide results (e.g., model outputs) substantially in real-time.

The blocks or states of the processes described herein may be embodied directly in hardware, in a software stored in a non-transitory memory and executed by a hardware processor, or in a combination of the two. For example, each of the processes described above may also be embodied in, and fully automated by, software modules (stored in a non-transitory memory) executed by one or more machines such as computers or computer processors. A module may reside in a non-transitory computer readable medium such as RAM, flash memory, ROM, EPROM, EEPROM, registers, hard disk, an optical disc, memory capable of storing firmware, or any other form of computer-readable (e.g., storage) medium. A computer-readable medium can be coupled to a processor such that the processor can read information from, and write information to, the computer-readable medium. In the alternative, the computer-readable medium may be integral to the processor. The processor and the computer-readable medium may reside in an ASIC. The computer-readable medium may include non-transitory data storage (e.g., a hard disk, non-volatile memory, etc.).

The processes, methods, and systems may be implemented in a network (or distributed) computing environment. For example, the central control unit or base station may be implemented in a distributed, networked, computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network, a terrestrial or satellite network, or any other type of communication network.

Depending on the embodiment, certain acts, events, or functions of any of the processes or methods described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially. In any apparatus, system, or method, no element or act is necessary or indispensable to all embodiments, and the disclosed apparatus, systems, and methods can be arranged differently than shown or described.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present. The words “or” in reference to a list of two or more items, is intended to cover all of the following interpretations of the word: any of the items in the list, all of the items in the list, and any combination of the items in the list. The articles “a” or “an” or “the” when referring to an element means one or more of the element, unless the context clearly indicates otherwise.

The words “coupled” or “connected”, as generally used herein, refer to two or more elements that may be either directly connected, or connected by way of one or more intermediate elements. Thus, although the various schematics shown in the figures depict example arrangements of elements and components, additional intervening elements, devices, features, or components may be present in an actual embodiment (assuming that the functionality of the depicted circuits is not adversely affected). The words “based on” as used herein are generally intended to encompass being “based solely on” and being “based at least partly on.” Additionally, the words “herein,” “above,” “below,” and words of similar import, when used in this application, shall refer to this application as a whole and not to any particular portions of this application. Where the context permits, words in the Detailed Description of Certain Embodiments using the singular or plural number may also include the plural or singular number, respectively. All numerical values or distances provided herein are intended to include similar values within a measurement error.

While the above detailed description has shown, described, and pointed out novel features as applied to various embodiments, it will be understood that various omissions, substitutions, and changes in the form and details of the logical blocks, modules, and processes illustrated may be made without departing from the spirit of the disclosure. As will be recognized, certain embodiments of the inventions described herein may be embodied within a form that does not provide all of the features and benefits set forth herein, as some features may be used or practiced separately from others.

What is claimed is:

1. A submersible vehicle comprising:
a hull;
a propulsion system coupled to the hull;
an opening in the hull to intake water; and
a first filter positioned to receive the intake water, the first filter having a first cross-sectional area at least 10% of a second cross-sectional area of the hull viewed in the direction of the intake; and
wherein an exterior of the submersible vehicle has a biomimetic appearance.

2. The submersible vehicle of claim 1, further comprising:
a second filter positioned to receive and filter the intake water that passes through the first filter;
wherein the first filter catches a first set of particles larger than a second set of particles caught by the second filter.

3. The submersible vehicle of claim 1, further comprising:
a storage container configured to store waste collected by the first filter, the storage container comprising:
a sealing opening; and
an inflatable flotation device coupled to the storage container.

4. The submersible vehicle of claim 3, further comprising:
a beacon coupled to the storage container.

5. The submersible vehicle of claim 3, wherein the inflatable flotation device is configured to inflate in response to a triggering condition comprising at least one of:
collecting a threshold amount of waste in the first filter;
completing a cleaning route;
reaching a location;
cleaning an area;
cleaning for a set amount of time;
reaching a proximity to a collection location; and
receiving an instruction to send waste for collection.

6. The submersible vehicle of claim 1, wherein the biomimetic exterior comprises a fin and a tail.

7. The submersible vehicle of claim 1, wherein the biomimetic exterior comprises gill-shaped openings.

8. The submersible vehicle of claim 1, wherein the propulsion system comprises a motor coupled to drive an impeller.

9. The submersible vehicle of claim 8, wherein the impeller draws water through the first filter when the impeller turns.

10. The submersible vehicle of claim 1, further comprising a battery coupled to deliver power to the propulsion system.

11. The submersible vehicle of claim 10, further comprising:
a wet docking attachment configured to dock the submersible vehicle to a base station while at least partially submerged; and
a wireless charging port receiver configured to receive energy while the submersible vehicle remains wet docked, wherein the wireless charging port is electrically coupled to the battery.

12. The submersible vehicle of claim 1, further comprising:
a plurality of sensors configured to collect data, including at least:
a GPS receiver; and
a sonar sensor; and
a processor configured to:
receive data from the plurality of sensors;
identify a topological feature; and
navigate the submersible vehicle in an area while avoiding the topological feature.

13. The submersible vehicle of claim 12, further comprising:
a plurality of sensors configured to collect data, including at least:
a GPS receiver;
a depth sensor;
a lidar sensor; and
a sonar sensor; and
a processor configured to use an object recognition model to recognize objects based at least in part on sensor data from the plurality of sensors.

14. The submersible vehicle of claim 1, further comprising:
a damage sensor;
a battery; and
a processor configured to send a signal to deliver electricity from the battery to the hull based at least in part on response to the damage sensor detecting damage.

15. A method comprising:
deploying a submersible vehicle into water to collect waste, the submersible vehicle comprising:
a hull contributing to a biomimetic appearance of the submersible vehicle;
a propulsion system coupled to the hull;
an opening in the hull to intake water; and
a first filter positioned to receive the intake water;
collecting the waste using at least one filter of the submersible vehicle; and
removing the waste from the filters in the submersible vehicle.

16. The method of claim 15, further comprising:
charging a battery of the submersible vehicle while the submersible vehicle remains at least partially submerged.

17. The method of claim 15, further comprising:
receiving a first communication from the submersible vehicle; and
in response to receiving the first communication, transmitting a second communication to a second submersible vehicle, and wherein the second submersible vehicle makes a navigational change in response to receiving the second communication.

18. The method of claim 15, further comprising:
receiving data from a plurality of submersible vehicles;
based at least in part on the data from a plurality of submersible vehicles, detecting an object traveling toward a second submersible vehicle; and
in response to detecting the object traveling toward a second submersible vehicle, sending a communication to the second submersible vehicle.

19. The method of claim 15, further comprising:
receiving data from a plurality of submersible vehicles;
based at least in part on the data from a plurality of submersible vehicles, determining that a first area is dirtier than a second area, wherein a second submersible is deployed to clean the second area; and
in response to the determining, sending a communication to cause the second submersible vehicle to clean the first area.

20. An aquatic base station deployed in water for supporting submersible vehicles, the base station comprising:
an attachment for docking a submersible vehicle;
a communication transceiver configured to communicate with a submersible vehicle;
a waste container for storing waste delivered by the submersible vehicle; and
a charging port for recharging an energy reservoir of the submersible vehicle.

21. The base station of claim 20, wherein:
the attachment for docking the submersible vehicle allows for wet docking beside or below the base station; and
the charging port is a wireless charging port configured to recharge an energy reservoir of the submersible vehicle while the submersible vehicle is wet docked.

22. A submersible cleaning vehicle comprising:
a filter;
a navigation sensor;
a propulsion system;
a processor;
a computer-readable storage medium storing instructions that, when executed by the processor, cause the processor to control the submersible cleaning vehicle to perform actions comprising:
navigating to a first area;
navigating within the first area to collect waste in the filter; and
returning to a base station.

23. The submersible cleaning vehicle of claim 22, further comprising at least one of a lidar or sonar sensor, and wherein the instructions are further configured to cause the processor to control the submersible cleaning vehicle to:
receive first data from the at least one of the lidar or sonar sensor;
identify, based at least in part on the first data, an obstacle within the first area; and
adjust a path to navigate within the first area while avoiding a collision with the obstacle.

24. The submersible cleaning vehicle of claim 22, further comprising at least one of a lidar or sonar sensor;
wherein the computer-readable storage medium further stores a marine creature identification model; and
wherein the instructions are further configured to cause the processor to control the submersible cleaning vehicle to:
receive first data from the at least one of the lidar or sonar sensor;
identify, based at least in part on the first data and using the marine creature identification model, a marine creature; and
in response to the identification of the marine creature, navigate away from the marine creature.

25. The submersible cleaning vehicle of claim 22, further comprising a storage sensor, and wherein the instructions are further configured to cause the processor to control the submersible cleaning vehicle to:
receive first data from the storage sensor indicating that at least a threshold amount of waste is collected;
navigate to a base station to empty the waste;
navigate back to the first area; and
resume navigating within the first area to collect more waste in the filter.

26. The submersible cleaning vehicle of claim 22, further comprising a storage sensor and a storage container, and wherein the instructions are further configured to cause the processor to control the submersible cleaning vehicle to:
receive first data from the storage sensor indicating that at least a threshold amount of waste is collected;
seal the waste in a storage container; and
release the storage container.
